(19) United States
(12) Patent Application Publication
(10) Pub. No.: US 2012/0037183 A1
(43) Pub. Date: Feb. 16, 2012

(54) ABSORBENT PROCESS FOR REMOVING EXTRANEOUS LIQUID FROM CONTACT LENS PACKAGING PRIOR TO SEALING

(76) Inventors: Shay James Foley, Snellville, GA (US); Kent M. Grothe, Buford, GA (US); Lawrence David Keyes, Spring, TX (US); Charles Henry Walton, IV, Birmingham, AL (US)

(21) Appl. No.: 13/207,137

(22) Filed: Aug. 10, 2011

Related U.S. Application Data
(60) Provisional application No. 61/373,023, filed on Aug. 12, 2010.

(51) Int. Cl. B08B 1/00

(52) U.S. Cl. 134/6; 15/97.1

(57) ABSTRACT

Extraneous liquid is absorbently removed from the rim or sealing area of a contact lens package prior to sealing it, so as to promote good adhesion of the foil cover to the rim when the package is sealed. As the package moves through the system, the package rim and an absorbent blotter are moved into contact with one another. The blotter absorbs any extraneous liquid on the rim. A vacuum or other dryer can be included to further remove the absorbed liquid from the blotter.

This application claims the benefit under 35 USC §119 (e) of U.S. provisional application Ser. No. 61/373,023 filed on Aug. 12, 2010, incorporated herein by reference in its entirety.

### BACKGROUND

1. Technical Field

The present invention relates generally to the packaging of ophthalmic contact lenses and, more specifically, to promoting good sealing of the contact lens package.

2. Description of the Related Art

As shown in FIGS. 1-2, hydrophilic ophthalmic contact lenses are commonly packaged in individual packages 10, generally known as “blister packages” or “blister packs.” A blister pack generally consists of a plastic (e.g., polypropylene) shell 12 having a bowl-shaped depression or cavity 13 in which a lens (not shown) is disposed immersed in a sterile aqueous solution (not shown) and sealed with a laminate foil cover 14. A flat rim 16 surrounds the cavity 13. (Shells 12 may include additional features to aid use and handling, but they are not shown for purposes of clarity.) As shown in FIG. 2, blister packages are generally manufactured in strips comprising a number, such as five, of adjoining blister packages that a user can easily separate by snapping them apart from one another. Such packaging keeps the lens in a hydrated and sterile state before being opened and worn by a user. Often, a lens is contained within a blister package for a significant amount of time while the lens is being shipped and held in storage before use. Therefore, it is important that the aqueous solution be hermetically sealed therein, to ensure that the solution cannot leak out and to prevent contaminants from entering the lens containment area. In one method of hermetically sealing the laminate foil to the plastic shell, a heating element or heated seal plate presses the laminate foil against the rim 16 to heat-seal the foil cover 14 to the shell.

Undesirable conditions during sealing can sometimes give rise to a poor, i.e., non-hermetic, seal between the foil cover 14 and the plastic shell 12. For example, droplets or moisture between the cover and seal area can create wrinkles in the foil cover and/or prevent the foil cover from properly adhering to the shell. These conditions can create undesired channels or pathways between the foil and bowl that can permit the aqueous solution to leak out of the blister package or contaminants to infiltrate the lens area.

Accordingly, needs exist for improvements to contact lens packaging systems that promote good, i.e., hermetic, seals between the cover and plastic shell of a blister package. The present invention is directed to these needs and others in the manner described below.

### SUMMARY

The present invention relates to a system and method for absorbently removing (such as by absorbent blotting) of extraneous liquid from the rim or sealing area of a contact lens package prior to sealing it, so as to promote adhesion of the foil cover to the rim when the package is sealed. In some embodiments of the invention, an absorbent blotter may be moved into contact with the rim of a contact lens package. In other embodiments, the contact lens package may be moved into contact with an absorbent blotter. In still other embodiments, both the contact lens package and absorbent blotter can move. For example, a conveyor can advance the contact lens packages toward a blotting position. In coordination with the advancement of a contact lens package into the blotting position, an actuator can extend the absorbent blotter into contact with the rim.

In some embodiments, the system can include a liquid-detecting sub-system for detecting moisture or a droplet on the rim and trigger the blotting or absorbent removing of liquid to occur only when such liquid is detected.

In some embodiments, the system can include a dryer subsystem for removing liquid from the absorbent blotter. The dryer can include a vacuum for removing liquid by suction. Alternatively or in addition, heating, wiping, squeezing, or other means for removing liquid from the absorbent blotter can be employed.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of embodiments of the invention are exemplary and explanatory only, and are not restrictive of the invention, as claimed.

### BRIEF DESCRIPTION OF THE DRAWINGS

FIG. 1 is a side elevation view of a blister pack in accordance with the prior art, showing the foil cover over the rim of the shell.

FIG. 2 is a top view of a strip of blister pack shells in accordance with the prior art.

FIG. 3 is a side elevation view of an absorbent system for blotting or wicking extraneous liquid from contact lens packages, such as the blister pack shells of FIG. 1, prior to sealing the package, showing the system in a first position, in accordance with one exemplary embodiment of the invention.

FIG. 4 is similar to FIG. 3 and shows the system in a second position, as it blots contact lens packages.

FIG. 5 is a side elevation view of another absorbent system for blotting or wicking or otherwise absorbently removing extraneous liquid from a contact lens package prior to sealing the package, in accordance with another exemplary embodiment of the invention.

FIG. 6 is a side elevation view of a portion of FIG. 5, enlarged to show the ribbon-shaped absorbent blotter in contact with contact lens packages.

FIG. 7 is a side elevation view of a portion of an absorbent blotter, showing an exemplary layered construction.

FIG. 8 is a side elevation view of still another absorbent system for blotting or wicking or otherwise absorbently removing extraneous liquid from a contact lens package prior to sealing the package, showing the system in a first position, in accordance with still another exemplary embodiment of the invention.

FIG. 9 is similar to FIG. 8 and shows the system in a second position, as it blots a contact lens package.

FIG. 10 is a flow diagram, illustrating a method for blotting or wicking or otherwise absorbently removing extraneous liquid from a contact lens package prior to sealing it.

FIG. 11 is a flow diagram, illustrating sub-steps of the method of FIG. 10.

### DETAILED DESCRIPTION OF EXEMPLARY EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in this specification (“herein”) including the appended claims, the singular forms “a,” “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. With regard to specific combinations of elements described herein, such elements can alternatively be combined in any other suitable manner with each other or with still other elements, and some elements can be omitted, or portions of the elements combined together with portions of other elements to form elements that differ from those specifically described. With regard to specific method steps described herein, unless otherwise stated, the steps can alternatively be performed in sequences other than those specifically described, and some steps can be omitted, or portions of the steps combined together to form steps that differ from those specifically described. Persons skilled in the art to which the invention relates will appreciate that the invention encompasses such alternatives.

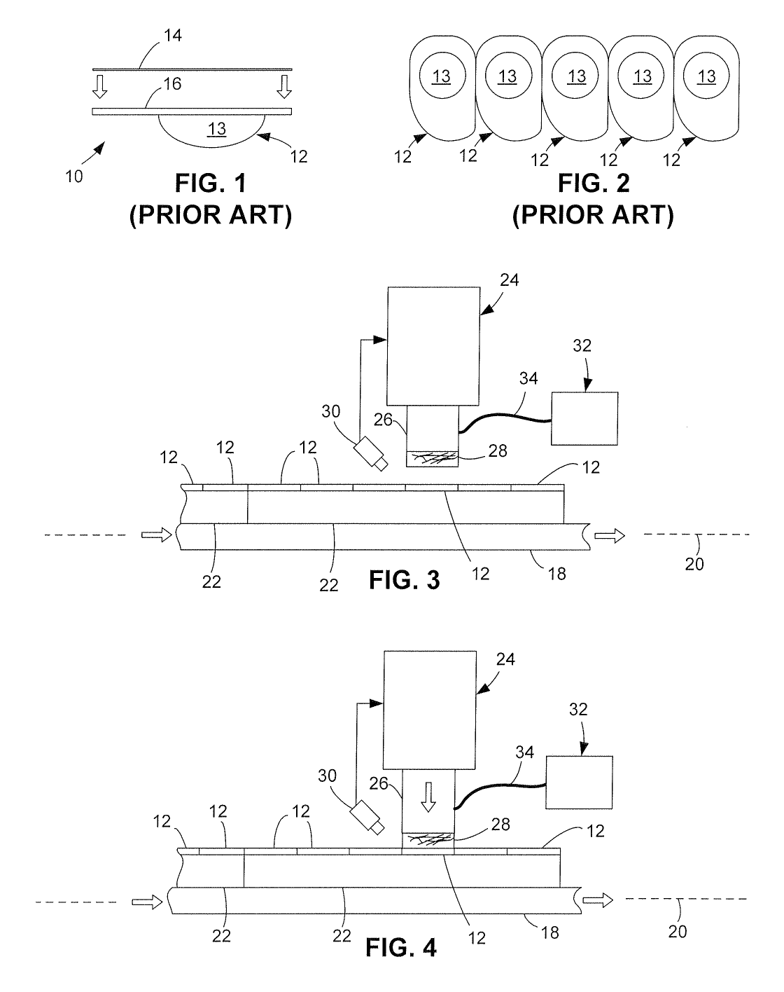

As illustrated in FIG. 3, a conveyor has a moving portion 18 (e.g., a belt) that carries contact lens package shells 12 in a direction, indicated by an axis 20 and corresponding arrows, toward a position where successive shells 12 are blotted as described below. Shells 12 are carried in a carrier tray 22 on conveyor moving portion 18. Carrier tray 22 can be of any suitable design, such as the conventional type commonly used in contact lens manufacturing to carry such shells 12 from one machine or process station to another. For example, such conveyors are commonly used to move a shell 12 from a station at which the lens is placed in the bowl-shaped depression or cavity 13 (FIG. 1) to a station at which the cavity 13 is filled with the aqueous solution, etc. Each carrier tray 22 carries, for example, a conventional strip of five shells 12 (see FIG. 2). The cavities 13 of shells 12 that arrive at the system of FIG. 3 from such previous stations in the manufacturing process have been filled with a contact lens and the aqueous solution at previous stations (not shown for purposes of clarity). Accordingly, it is possible that during the filling step some of the solution may have splashed upon or otherwise undesirably become disposed upon the rim or area immediately surrounding cavity 13 (sometimes also referred to in the art as the sealing area, as it is this area to which foil cover 14 (FIG. 1) is to be adhered).

In the embodiment illustrated in FIG. 3, an actuator subsystem 24, which can operate electrically, pneumatically or in any other suitable manner, has a piston-like member 26 with a pad-shaped absorbent blotter 28 attached to its distal end. The term “blotter” is used herein to mean a piece of absorbent material of a suitable size and shape to absorb or wick (e.g., through capillary action) moisture, droplets or other liquid from the rim or sealing area of shell 12. The term “blotting” is used herein to mean the absorbent or wicking action of a piece of absorbent material to remove liquid. As illustrated in FIG. 4, when actuator subsystem 24 is activated, it causes member 26 to extend downwardly, i.e., perpendicularly to axis 20, (or, alternatively, in other embodiments it could extend in another suitable direction) in a piston-like manner until absorbent blotter 28 contacts the rim of the shell 12 that the conveyor has positioned beneath absorbent blotter 28, or at least until the blotter contacts a droplet in the sealing area to wick the droplet off of the shell (at the “blotting position”). The contact between absorbent blotter 28 and the rim causes liquid on the rim to be drawn into absorbent blotter 28 by absorption or capillary action. Desirably most or substantially all of such liquid is drawn into the absorbent blotter 28. After this blotting has been performed, actuator subsystem 24 lifts member 26 or otherwise causes it to retract. The conveyor then advances the next shell 12 to be blotted into the blotting position, and advances the shell 12 that has just been blotted out of the blotting position, in the direction indicated by the arrows and axis 20 in FIGS. 3-4. Persons skilled in the art to which the invention relates will appreciate that the actuator mechanism of subsystem 24 can operate in any suitable manner known in the art. For example, in other embodiments it can passively allow gravity to drop absorbent blotter 28 and then actively retract it after blotting. Also, although in the illustrated embodiment, the actuator mechanism moves in a linear manner, in other embodiments it can move in any other suitable manner, such as by rotating an absorbent blotter or portion thereof into contact with a shell 12 in a rotary manner.

Actuator subsystem 24 optionally includes suitable control electronics that control its activation, and/or can be linked to the operation of other components of the production system. For example, it can activate each time the conveyor advances another shell 12 into the blotting position. Alternatively, it can activate only in response to detection of liquid on the rim of the shell 12. The liquid detector can comprise a suitable camera system 30 and associated electronic image processing circuitry in subsystem 24. When the liquid detector detects liquid on the rim of a shell 12, it signals the actuator to blot that shell 12 in the manner described above.

A dryer subsystem 32 can also be included for removing liquid from absorbent blotter 28. Dryer subsystem 32 can comprise, for example, a vacuum or suction pump (not separately shown) that draws liquid by suction from absorbent blotter 28 and deposits the liquid in a collection vessel for disposal. In such an embodiment, the distal portion of member 26 can be a hollow cylinder or have an internal passage, such that the distal end of the cylinder acts as a suction nozzle against the absorbent blotter 28 attached to it. A suitable hose 34 or other conduit can couple the vacuum pump in dryer subsystem 32 to the member interior or passage. Dryer subsystem 32 can include suitable control electronics, in electronic communication with actuator subsystem 24, to control when the vacuum is activated. For example, it can be activated each time a shell 12 is blotted. Alternatively, it could be activated on a timed basis, such as every few minutes, or on any other suitable basis. It can be activated while a shell 12 is being blotted or, alternatively, between blotting one shell 12 and the next. In other embodiments, the dryer can use means for removing liquid other than or in addition to suction (vacuum), such as heat and/or a fan or blower.

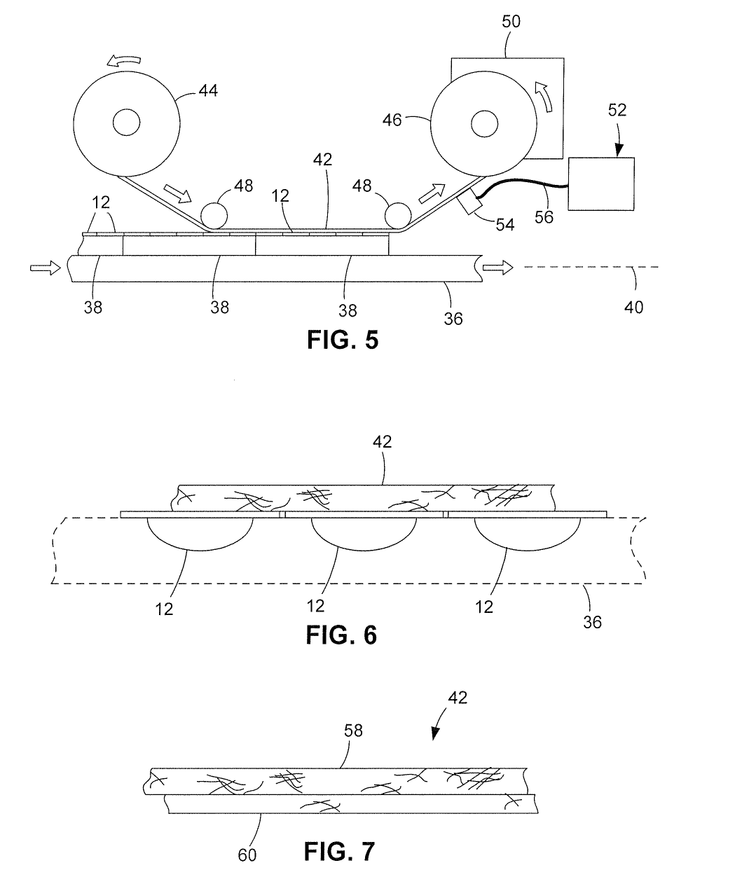

As illustrated in FIG. 5, in another exemplary embodiment, the moving portion 36 of a conveyor like that described above with regard to FIGS. 3-4 carries shells 12 in carrier trays 38 in the direction indicated by an axis 40 and corresponding arrows, toward a blotting position where shells 12 are blotted by a ribbon-like absorbent blotter 42. Absorbent blotter 42 is wound about two reels 44 and 46 and guided by suitable guide rollers 48 toward the blotting position. Reel 44 is a supply reel on which a supply of absorbent blotter ribbon 42 is wound in preparation for operation. Reel 46 is a take-up reel that accepts absorbent blotter 42 after having been used in blotting. A suitable actuator 50 drives take-up reel 46 or otherwise causes absorbent blotter 42 to unwind from supply reel 44, move through the blotting position between reels 44 and 46, and become wound about take-up reel 46. Successive shells 12, carried on trays 38 (e.g., five to a tray), move in coordination with this movement of absorbent blotter 42 such that they successively come into contact with absorbent blotter 42 in an essentially continuous blotting process. The blotter ribbon may be advanced with each successive shell, after blotting a set number of shells, after reaching a predetermined level of moisture saturation, or according to some other protocol. After blotting, shells 12 similarly continue moving in the same direction (e.g., toward another station or process step, as described further below). Note that, alternatively, actuator 50 could be omitted in an embodiment in which absorbent blotter 42 is passively driven by the frictional contact with the rims of shells 12. In the depicted embodiment, the blotter ribbon advances in a direction parallel to the conveyor direction. In alternate embodiments, the blotter ribbon advances crosswise or perpendicular to the conveyor direction, or obliquely thereto.

A dryer subsystem 52, like that described above with regard to FIGS. 3-4, can also be included in the embodiment shown in FIG. 5 for removing liquid from absorbent blotter 42. Accordingly, a nozzle or similar portion 54 abuts absorbent blotter 42 and is coupled via a suitable hose 56 or other conduit to the vacuum pump (not separately shown) in dryer subsystem 52. Although portion 54 is shown as abutting absorbent blotter 42 outside of the blotting position, alternatively, it could be disposed inside the blotting position, abutting the surface of absorbent blotter 42 opposite that which contacts shells 12. In alternate embodiments, the blotter ribbon forms a continuous loop, with successive portions being dried between blotting sequences.

A portion of the blotting position described above with regard to FIG. 5 is shown in enlarged form in FIG. 6 (with carrier tray 38 shown in dashed line for clarity), showing how absorbent blotter 42 contacts a number of the rims of successive shells 12 to blot them of liquid. The blotting position and blotting action for the embodiment shown in FIGS. 3-4 are essentially the same as in this embodiment (FIGS. 5-6), but the blotting position covers only a single shell 12 in FIGS. 3-4 whereas the blotting position may cover several shells 12 in this embodiment. Note that features of carrier trays 38, which can be of any suitable conventional design, such as indexing pins and receptacles for seating shells 12, are not shown in any figure for purposes of clarity.

Absorbent blotter 42 is shown in further detail in FIG. 7. Note that it can comprise more than one layer, such as an upper layer 58 of non-woven polyester fiber matting bonded to a lower layer 60 (i.e., the layer that contacts shells 12) of non-woven ultra-high molecular weight (UHMW) super-absorbent polyester fiber matting. These materials and layered structure are intended only to be exemplary, and persons skilled in the art to which the invention relates will recognize many other suitable materials and arrangements of one or more layers, in view of the teachings herein. Absorbent blotters included in the other embodiments described herein can similarly have any such suitable structure.

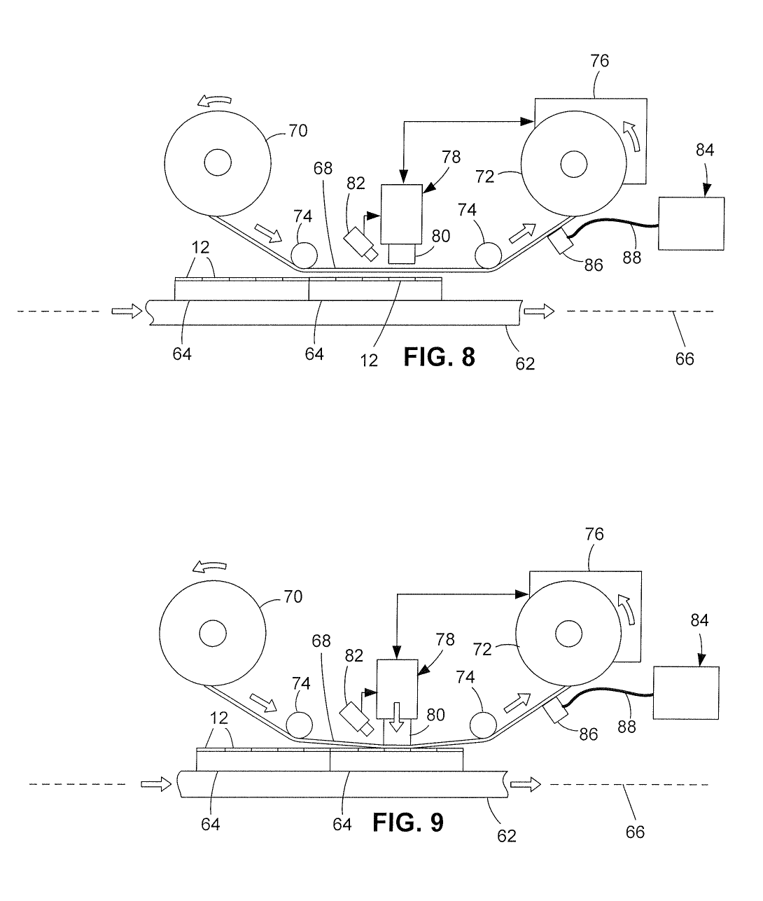

As illustrated in FIGS. 8-9, another embodiment can be similar to that described above with regard to FIG. 5 but which, rather than continuously blotting successive shells 12 as they pass through a multi-shell blotting position, blots shells 12 individually at a single-shell blotting position. The moving portion 62 of a conveyor like that described above with regard to FIGS. 3-5 carries shells 12 in trays 64 in the direction indicated by an axis 66 and corresponding arrows, toward a blotting position where shells 12 are blotted by a ribbon-like absorbent blotter 68. Absorbent blotter 68 is wound about supply and take-up reels 70 and 72 and guided by suitable guide rollers 74 in the same manner as described above with regard to FIG. 5. A suitable actuator 76 drives take-up reel 72 or otherwise causes absorbent blotter 42 to unwind from supply reel 70, move through the blotting position, and become wound about take-up reel 72.

In some embodiments, movement of the conveyor is indexed, and blotting occurs only when the conveyor halts movement of shells 12, with a shell 12 in the blotting position. In other embodiments, movement of the conveyor is continuous, and the blotting actuation is timed to the conveyor movement. As in the embodiment of FIGS. 3-4, an actuator subsystem 78, which can operate electrically, pneumatically or in any other suitable manner, has a piston-like member 80. Note in FIG. 8 that absorbent blotter 68 is spaced from (and held taut above) the rims of shells 12 before blotting. Then, as illustrated in FIG. 9, when actuator subsystem 78 is activated, it causes member 80 to extend downwardly, i.e., perpendicularly to axis 66, (or, alternatively, in other embodiments it could extend in another suitable direction) in a piston-like manner, and urge a portion of absorbent blotter 68 into contact with the rim of the shell 12 that the conveyor has positioned beneath member 80 at the blotting position, or at least into wicking contact with any droplets thereon. The contact between absorbent blotter 68 and the rim or droplets thereon causes any liquid on the rim to be drawn into absorbent blotter 68 by absorption or capillary (wicking) action. After this blotting has been performed, actuator subsystem 78 lifts member 80 or otherwise cause it to retract. The conveyor then advances the next shell 12 to be blotted into the blotting position, and advances the shell 12 that has just been blotted out of the blotting position.

Actuator subsystem 78 includes suitable control electronics that control when it activates. For example, it can activate each time the conveyor advances another shell into the blotting position. Alternatively, it can activate only in response to detection of liquid on the rim of the shell 12. The liquid detector can comprise a suitable camera system 82 and associated electronic image processing circuitry in actuator subsystem 78. When the liquid detector detects liquid on the rim of the shell 12 then in the blotting position, it signals the actuator to blot the shell 12 in the manner described above. Following blotting, the actuator 76 that drives take-up reel 72 can be signaled to advance absorbent blotter 68 by a suitable amount, such as the length of a single shell 12 (“shell spacing”). Actuators 76 and 78 can thus operate to advance both shells 12 and absorbent blotter 68 in such a coordinated or synchronized manner.

A dryer subsystem 84, like that described above with regard to FIGS. 3-5, can also be included in the embodiment shown in FIGS. 8-9 for removing liquid from absorbent blotter 68. Accordingly, a nozzle or similar portion 86 abuts absorbent blotter 68 at a suitable position along its length and is coupled via a suitable hose 88 or other conduit to the vacuum pump (not separately shown) in dryer subsystem 84.

Although only single-conveyor systems are described above for purposes of clarity, it should be understood that the system can include multiple conveyors and blotting systems operating in parallel.

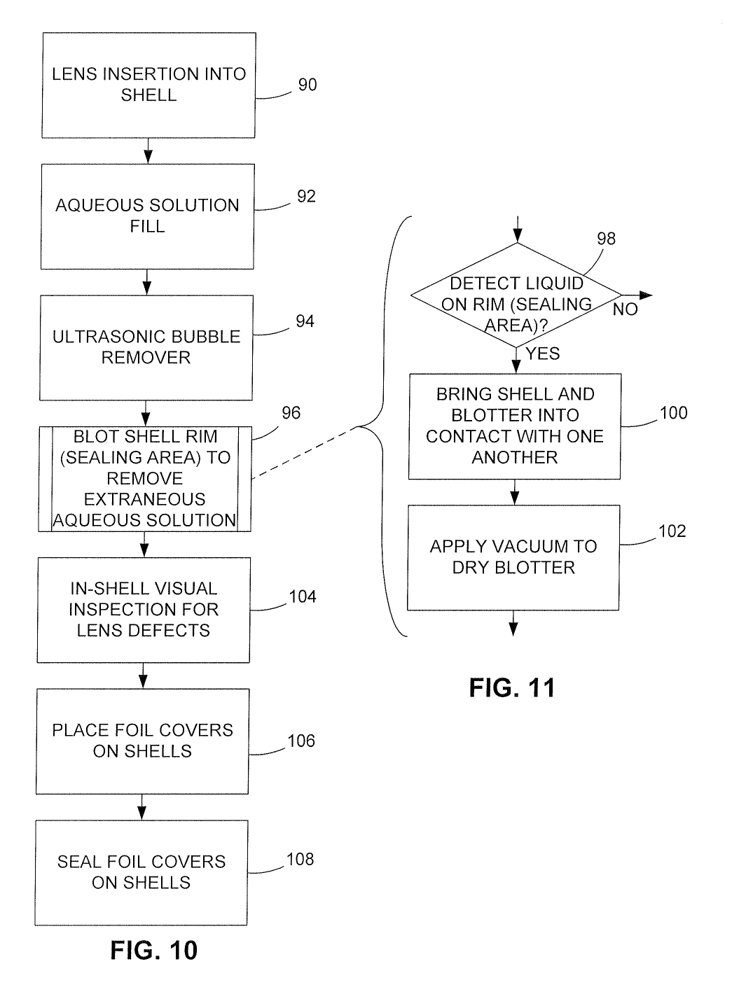

As illustrated in FIGS. 10-11, an exemplary method for removing extraneous liquid using the systems described above can be performed in conjunction with one or more of the process steps or stations of a conventional contact lens manufacturing process line. As these steps are performed, shells 12 are carried in the carrier trays in the manner described above, or otherwise conveyed through the stations or machines at which the process steps are performed. First, the conventional steps 90 and 92 of placing a contact lens (not shown) into a shell cavity and filling the cavity with aqueous solution, respectively, are performed. The steps can be performed continuously, such that successive shells 12 are filled as they pass through the lens placement and solution-filling stations (not shown). At step 94, the filled shells 12 are optionally conveyed into a station (not shown) that uses ultrasonic vibration to remove any bubbles in the solution, as such bubbles could interfere with optical inspection of the lenses at a subsequent station. Although the ultrasonic bubble remover station is conventional, it is contemplated that the blotting station can be integrated with this station in a suitable manner. Thus, at step 96, the shells 12 can optionally be blotted in the manner described above in conjunction with vibrational bubble removal.

As described above, and with further reference to FIG. 11, the blotting step 96 can comprise sub-steps 98, 100, and 102 of, respectively: detecting whether there is any liquid on the rim of a shell; bringing the shell and a portion of the absorbent blotter into contact with one another if liquid is detected; and applying a vacuum or otherwise drying a portion of the absorbent blotter to remove some of the liquid. As noted above, the steps can be performed in any suitable order and at any suitable time with respect to each other and other steps.

Following bubble removal, the conventional step 104 of optically inspecting each lens by imaging the lens through the cavity area of shell 12 using a camera and image-processing equipment (not shown) can be performed.

At step 106, shells 12 arrive at a station (not shown) that places the above-described foil covers 14 (see FIG. 1) on them and, at step 108, seals each cover to the rim in a conventional manner, such as by applying a heat-sealing plate (not shown). The likelihood that a good seal will result is increased because the extraneous liquid is removed, as are contaminants or debris that may have become disposed upon the rims during the filling or other steps described above.

While the invention has been described with reference to preferred and example embodiments, it will be understood by those skilled in the art that a variety of modifications, additions and deletions are within the scope of the invention, as defined by the following claims. With regard to the claims, no claim is intended to invoke the sixth paragraph of 35 U.S.C. Section 112 unless it includes the term “means for” followed by a participle.

What is claimed is:

1. A method for removing extraneous liquid prior to sealing a contact lens package, comprising:
moving at least one of a contact lens package and an absorbent blotter into contact with the other, the contact lens package having a concave interior and a rim, the absorbent blotter contacting extraneous liquid on the rim and thereby blotting the rim of said extraneous liquid; and
moving at least one of the contact lens package and the absorbent blotter out of contact with the other.

2. The method claimed in claim 1, wherein the absorbent blotter has a pad-like shape, and wherein the step of moving at least one of the contact lens package and the absorbent blotter into contact with the other comprises:
moving the contact lens package along a first axis; and
moving the absorbent blotter along a second axis perpendicular to the first axis.

3. The method claimed in claim 1, further comprising removing liquid from the absorbent blotter.

4. The method claimed in claim 3, wherein the step of removing liquid from the absorbent blotter comprises applying vacuum to the absorbent blotter.

5. The method claimed in claim 2, further comprising removing liquid from the absorbent blotter.

6. The method claimed in claim 1, further comprising:
determining if liquid is present on the rim; and
not performing the step of moving at least one of the contact lens package and the absorbent blotter into contact with the other if liquid is not present on the rim.

7. A system for removing extraneous liquid prior to sealing a contact lens package, comprising:
a conveyor having a movable portion adapted to carry a plurality of contact lens packages along a first axis toward a blotting position;
an absorbent blotter; and
an actuator acting in coordination with the conveyor to move at least one of the absorbent blotter and a contact lens package into contact with one another at the blotting position to thereby blot a rim of the contact lens package of any extraneous liquid.

8. The system claimed in claim 7, further comprising a dryer having a portion in contact with the absorbent blotter to remove liquid from the absorbent blotter.

9. The system claimed in claim 8, wherein the dryer comprises a vacuum device.

10. The system claimed in claim 7, wherein:
the actuator is coupled to the absorbent blotter and moves the absorbent blotter along the first axis into contact with the contact lens package.

11. The system claimed in claim 7, wherein the actuator is coupled to the absorbent blotter and moves the absorbent blotter along a second axis perpendicular to the first axis into contact with the contact lens package

12. The system claimed in claim 11, further comprising a liquid detection subsystem for providing a signal to the blotter actuator in response to detecting liquid on the rim, wherein the actuator does not move the absorbent blotter into contact with the contact lens package unless liquid is detected on the rim.

13. The system claimed in claim 8, wherein the dryer applies a vacuum to the absorbent blotter each time the conveyor moves a contact lens package into the blotting position.

14. The system claimed in claim 9, wherein the dryer applies a vacuum to the absorbent blotter each time the conveyor moves a contact lens package into the blotting position.

15. A system for removing extraneous liquid prior to sealing a contact lens package, comprising:
means for moving at least one of a contact lens package and an absorbent blotter into and out of contact with the other, the contact lens package having a concave interior and a rim, the absorbent blotter contacting the rim and thereby blotting the rim of any extraneous liquid.

16. The system claimed in claim 15, wherein the absorbent blotter has a ribbon-like shape, and wherein the means for moving at least one of the contact lens package and the absorbent blotter into and out of contact with the other comprises:
means for moving the contact lens package along a first axis; and
means for moving the absorbent blotter along a second axis perpendicular to the first axis.

17. The system claimed in claim 15, further comprising means for removing liquid from the absorbent blotter.
